(19) United States
(12) Patent Application Publication
(10) Pub. No.: US 2001/0048443 A1
(43) Pub. Date: Dec. 6, 2001

(54) Method and system for changing the display of one texture to another in a computer graphics system

(76) Inventor: Jeffrey Burrell, Raleigh, NC (US)

Correspondence Address: David L. McCombs, Haynes and Boone, LLP, 901 Main Street, Suite 3100, Dallas, TX, 75202-3789, US

(21) Appl. No.: 09/835,749

(22) Filed: Apr. 16, 2001

Related U.S. Application Data
(60) Provisional application No. 60/197,552, filed on Apr. 17, 2000.

(51) Int. Cl. G09G 5/00

(52) U.S. Cl. 345/582

(57) ABSTRACT

A system and method is provided for efficiently accomplishing texture transformation from an initial state to a final state. Only an initial and a final texture, and the number of desired intermediate textures are transmitted to a local computer system from a remote computer system. A control channel bears information of the desired number of intermediate textures and is used for controlling which pixels are to be changed and how fast they are changed. In one example, a portion of the initial texture is changed to its final texture in each intermediate texture. In another example, the colors of the initial texture change gradually into the final texture by changing the values of the color components of each pixel in each intermediate texture by a predetermined step value.

### CROSS-REFERENCE

This application claims the benefits of the provisional application of U.S. patent application Ser. No. 60/197,552 which was filed on Apr. 17, 2000.

### BACKGROUND OF THE INVENTION

The present invention relates generally to data processing for computer graphics, and more particularly, to a system and method for processing the display of one texture of computer-based graphics to another.

As it is known in the industry, a computer-based graphics processing system renders two or three-dimensional objects for display on a two-dimensional display device. In such a system, the surfaces of the rendered objects are displayed as “textures.” The textures represent a realistic appearance of the objects in a displayed graphic image by overlaying other graphic images on all or part of the displayed graphic image. These textures may be simple, such as those that are monochromatic, but most likely are arbitrarily complex as in various modern graphic applications. Complex textures are initially generated by graphics artists at the time when a graphical object to be displayed is defined, or created through a computer process.

In a computer network environment, graphics are often created in one place on one computer and displayed or retrieved in another place on another computer. Transferring data for the graphics can result in certain inefficiencies. First, the creation of the images and textures at a remote computer system by graphic artists is oftentimes a skilled and expensive (in human and computer time) operation.

In addition, the responsiveness of displaying images as seen by an operator of a local computer depends largely on the amount of data transmitted between the local and remote computers and the speed of a communications link between the two computer systems. Thus, a large data flow between the two computer systems can detrimentally affect the image display on the local computer. It is often the case when a change is made to the image being displayed, a texture of the image being displayed must be changed as well. The initial and final states of the texture must first be determined, and the number of intermediate textures is set as a function of the “smoothness” of the transition desired. It is a common practice in the network environment to require each intermediate texture to be defined by the graphics artists, stored at the remote computer first, transmitted to the local computer when requested, and further transmitted from the local computer to its display device. Depending on the degree of changes between the initial and final textures and the number of intermediate textures required, the amount of data transmitted from the remote computer to the local computer and further to the display device may be considerable, thus affecting the apparent responsiveness of the graphical image display in the local computer system. This cumbersome process has been one of the major problems for image processing and image presentation.

Further, although some parts of the image may not change between the initial and final textures, the conventional display method still requires that these stationary parts of the image be created and transmitted as new ones with other changing parts of the texture. This also contributes significantly to the aggregated size increase of the data created and communicated between the local and remote computer systems.

There are times when the initial and final textures are known and the sequence of intermediate textures is important to a smooth display of the image. For instance, the technique of “morphing” is one of such case where the sequence of changes from one image to another is vital to the visual effect desired. But more often, the sequence is not important such as in a regular “decay” or transformation of one texture to another. Hence, in most cases for graphical presentations, barring some special effects, it is not important to determine which pixels have changed in each intermediate texture. What matters to the operator of the local computer system is that the pixels of the image have changed from its initial texture to its corresponding final texture. The conventional method disregards this feature, and still requires that all the intermediate textures be clearly defined and transmitted where a decay from the initial texture to the final texture is desired.

A method is thus needed for efficiently transforming the textures from their initial state to the final state and transferring a controlled amount of graphics data from one computer system to another.

### SUMMARY OF THE INVENTION

A system and method is provided to accomplish texture transformation from an initial state to a final state. Also provided is a technique for using an control channel of a graphic image to control which pixels are to be changed and how fast they are changed.

Both the initial and final textures are transmitted from a remote computer to a local computer along with a predetermined number of intermediate textures. In one example, the number of intermediate textures may be transmitted as a control value. The local computer inspects the control value in order to create intermediate textures appropriately in sequence. In particular, the local computer creates the next intermediate texture by inspecting the control value for each pixel. If the value is zero, the color of the pixel in this texture is constant and subject to no further change. If it is not, the values of color components of the pixel is determined instantly.

In another example, a probability selection method is used for transforming the image. For each pixel, if the color is already that of the final texture, the final color value remains. And if the color is represented by the initial texture value, a calculation is used to determine if the color is expected to change in an intermediate texture. If the color is supposed to change, the texture values of the color components of the final texture is used; if not, the initial texture value is used. Pixels expected to change are selected randomly in each intermediate step for transforming the entire image from its initial texture to its final texture.

In another example, a color-transition method is used. A step-by-step approach is used to create intermediate textures that bear intermediate color changes. New values of the color components of the intermediate texture are obtained from the values of the color components (red, green, and blue values) of the initial and final textures, and the number of the intermediate textures expected.

### BRIEF DESCRIPTION OF THE DRAWINGS

FIG. 1 illustrates a simplified computer network system used for creating, transmitting and displaying computer graphics throughout the network.

FIG. 2 is a flow diagram for processing data for displaying computer graphics on a local computer display device in the computer network system of FIG. 1.

FIG. 3a illustrates a detailed transformation process of a monochromatic graphical image from its initial texture to a desired final texture by using a probability selection method according to one embodiment of the present invention.

FIG. 3b illustrates a detailed transformation process of a non-monochromatic graphical image from its initial texture to a desired final texture by using a probability selection method according to another embodiment of the present invention.

FIG. 4 illustrates a detailed transformation process of a graphical image from its initial texture to a desired final texture by using a color-transition method according to another embodiment of the present invention.

### DETAILED DESCRIPTION OF THE PRESENT INVENTION

The present invention relates to computer graphic image transformation where initial and final textures of a graphic image are known or determined, and where a “decay” from the initial to the final texture needs to take place.

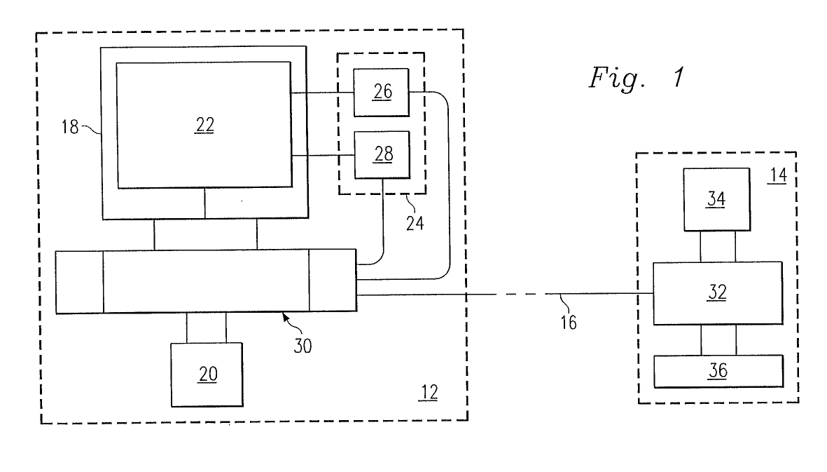

Referring to FIG. 1, a computer network environment is shown in which the present invention may be implemented. A computer network system 10 is shown wherein one local computer system 12 is connected to at least one remote computer system 14 through a communications link 16 such as a network cable line. While other connections and communications are contemplated, the infrastructure represents a simplified topological layout of a networked environment such as the Internet. It is understood that the communications link 16 can be implemented by modern wired or wireless telecommunication technologies. In such an environment, graphics to be displayed on the local computer system 12 may be initially created and stored in the remote computer system 14 until retrieved to satisfy a request from an operator of the local computer system 12. In this environment, the amount of data to be transmitted instantaneously from the remote computer system 14 upon the request from the local computer system 12 may be, in some cases, considerable in order to display a large or detailed graphic.

The local computer system 12 usually has a display 18, and a local storage device 20 where images may be stored until needed. This local storage device 20 may be a magnetic medium, for example, a disk drive, or may be memory-based storage. The display 18 has a two-dimensional image area 22 for displaying images. In addition, the display 18 has a “graphics subsystem” 24 including one or more image-specific processors 26 and an image storage 28. These special purpose processors 26 and the storage 28 allow for high-speed display of images. The key component of the local computer system 12 is a local computer 30 which integrates a central processor unit along with various other electronic components. As it is understood in the industry, current display technology allows 32 bits of information to be simultaneously sent from the local computer 30 to the graphics subsystem 24. The responsiveness of displaying images also depends on an intelligent use of the graphics subsystem 24. Using the high-speed, but limited, image storage 28 optimally in the graphics subsystem 24 is also an important contributing factor for producing satisfying graphical displays. Furthermore, the local computer 30 possesses software and hardware components for communicating with the display 18 to indicate what is to be displayed. The local computer 30 also has software and hardware components for communicating with the remote computer system 14 via the communications line 16. The remote computer system 14 also has a remote computer 32, a display 34, and an image storage mechanism 36, which contains images and textures that might be displayed either on the display 34 connected to the remote computer 32 or delivered to the local computer 30.

In addition to the above-mentioned hardware, there are predefined communication protocols between the local computer 30 and the graphics subsystem 24. These protocols define available commands and formats of data streams for communications between the local computer 30 and the graphics subsystem 24. In order to enhance the acceptability of these protocols, or more specifically, the definition of the format of color encoding (i.e., Red, Green, Blue, Alpha), and the definition of texture arrays, the protocols may conform to the OpenGL Specification 1.2.1, the content of which is publicly accessible from www.opengl.org and is herein incorporated by reference. However, other functionally similar specifications or standards may also be used.

When the remote computer 32 delivers graphics information to the local computer 30 through the communications link 16, both the images and information about their corresponding textures are sent. Between the local and remote computers, an additional communication protocol is defined by which the needed images or textures are readily identified and sent to the local computer 30 from the remote computer 32. Running in the remote computer 32, among others, is a computer process by which graphic artists create and define images and textures, catalog them, and store them at the remote computer 32 in order to be later displayed at the local computer display 22. And similarly, there is a computer process running in the local computer 30 for identifying what images or textures are needed to satisfy a request by an operator of the local computer.

As it is known in the industry, a representation of images is composed of individual points of light, called “pixels” (for “picture element”). Current art defines a pixel as represented by an array of 32-bit numbers. It is further understood that using a 24-bit number is sufficient to distinguish between approximately 16.7 million different colors, more than the human eyes can discern. It is common in the industry to further group the 32 bits of each 32-bit number into three eight-bit subgroups, each subgroup representing the red, green, and blue components of the color. These subgroups are referred to as the red channel, the green channel, and the blue channel. The remaining eight bits are for a control channel or referred to as the “alpha channel” for historical reasons, which are available for controlling communications between the graphics subsystem 24 and the local computer 30.

For the purpose of illustrating the present invention, the initial texture is defined as a rectangle of pixels, each of which has a red, a green, and a blue components, or color values, producing an expected resulting color to be displayed, and an alpha component or alpha value to be used as a control mechanism for generating the intermediate textures in the local computer system 12. Similarly, the final texture is also defined with red, green, and blue components, while its alpha component is ignored in the process. As discussed below, a process is herein described wherein information in the alpha component can be used as a control value such that it is no longer required to create and transfer intermediate textures from the remote computer system 14 to the local computer system 12 after the transmission of the initial and final textures and the control value.

In at least one embodiment of the present invention, the meaning of a predefined value set for the alpha component is defined as follows:

1. A value of zero means that the pixel color is not to change between the initial and final textures. In this case, the color value in the final texture is ignored.

2. A non-zero value indicates the transformation “speed” at which the color goes from the initial value to the final value. The speed may be either:

a. the probability that the color value jumps from the initial to the final value, or

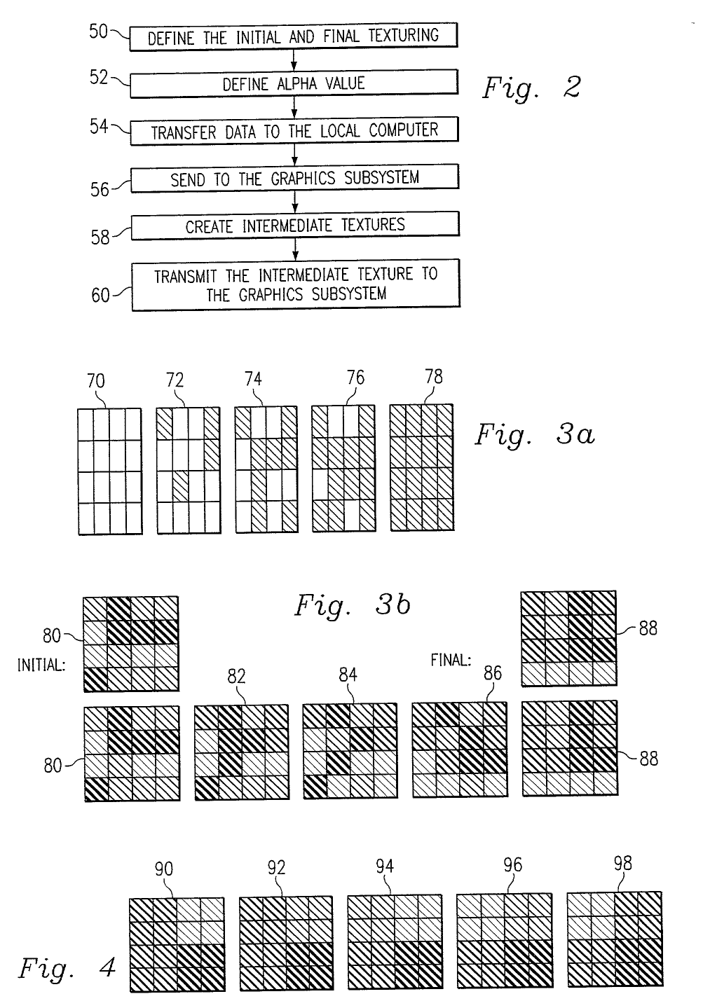

b. the speed at which the color values move from the initial value to the final value. Referring to FIG. 2, the general process of transforming any image texture of at least a portion of a graphical image from its initial texture to its final texture is illustrated. In step 50, the portion of the graphical image with the initial and final textures is assumed to maintain the same size throughout the changes. The control or alpha value for the initial texture is defined according to the guidelines provided above for each pixel (step 52). After all these parameters are defined, both the initial and final textures are transmitted from the remote computer 32 (FIG. 1) to the local computer 30 (FIG. 1) in step 54 along with a predetermined number of intermediate textures to be created. In one embodiment of the present invention, the number of the intermediate textures may be transmitted in the alpha channel as an alpha value. In step 56, the local computer 30 first sends the initial texture to the graphics subsystem 24 for display. The local computer 30 inspects the number of the intermediate textures in order to create them appropriately in step 58. Basically, the local computer 30 creates the next intermediate texture by inspecting the control value for each pixel. If the value is zero, the color of the pixel in this texture is constant. If it is not, the value of the pixel may have to be determined instantly. In this embodiment, if the color is already that of the final texture, the final color value is used. And if the color is represented by the initial texture value, a mathematical calculation is used to determine if the color is expected to change in the particular intermediate texture.

After each pixel of the image is configured to have an appropriate texture, the intermediate texture is then transmitted to the graphics subsystem for display in step 60. Eventually, through a number of intermediate textures, the last texture transmitted to the graphics subsystem is the final texture. Due to the fact that the local computer system 12 can create necessary intermediate textures by itself, data creation and data transmission from the remote computer system 14 have drastically reduced to a minimum.

Referring now to FIG. 3a, a series of sample textures shown for illustrating how a simple monochrome texture 70 “shifts” into a monochromatic black color texture 78 in four steps using a probability selection method according to one example of the present invention. It is assumed that the monochrome texture 70 is a four-by-four pixel texture. Hence, there are altogether sixteen pixels in the texture 70. In various graphical applications, a typical texture in a graphics display would likely be a square of 128 pixels by 128 pixel, while other sizes may also be used. It is further assumed that each pixel in this example has the same red, green, and blue values of 60, 150, 160. It is understood that the black color has a red, green, and blue value of 0, 0, 0. Moreover, it is predetermined in this example that the control channel setting for each pixel is 64, which is one quarter of the maximum value of 256.

When the control value is set at 64 for each pixel, it means that one quarter (64/256) of the pixels are expected to go to the final color value in each intermediate step. However, which pixels are changed in each step is determined randomly. Assuming in the above example, the first illustrated texture is a “gray” texture 70. The second texture 72 is the result of setting one fourth of the pixels randomly to black. The third and fourth textures (represented by numerals 74 and 76) are the results of setting another one fourth of the pixels randomly to black in each step. Finally, as shown by the texture 78, all pixels are made black.

It is understood that if the initial texture and final textures are not monochrome, similar steps will be taken for each color component. FIG. 3b illustrates such a transformation process for a non-monochrome texture according to another example of the present invention. As it is shown, the initial texture 80 is transformed into the final texture 88 through intermediate textures 82, 84, and 86, such that at each intermediate step, a portion of the total pixels are changed from the initial to the final pixel color directly.

The following is a portion of example pseudo code for implementing the process of transforming the initial texture to the final texture through “N” steps by using the probability selection method:

Let initial[m:n] be the m by n array containing the initial texture

Let final[m:n] be the m by n array containing the final texture

Each element of initial and final are a 4-tuple of (R, G, B, A) containing the reg, green, blue, and alpha values of the pixel

Let N be the number of textures to build and send to the graphics subsystem

Let Temp be a vector of length m*n elements, each a 3-tuple of (M, N, P) containing the [m,n] array address and probability value (calculated)

Z=0 The number of pixels with alpha=0

For I=1 to m Search the initial array and count alpha=0

For J=1 to n

If alpha(initial[I,J])=0 then Z=Z+1

End

End

For I=1 to N Build each new texture

P=m*n−Z Number of pixels with non-zero alpha

C=floor(P/N) Number of pixels to change this texture

For J=1 to mprocess rows

For K=1 to n process columns

L=m*(J−1)+K calculate vector position

Prob=Random(0,1)*alpha(initial[J,K])

Temp[L]=(J, K, Prob) build temp vector

End

End

Temp[ ]=Sort(Temp[ ]) by decreasing (*,*,Prob) Sort temp vector

For J=1 to C Select first C elements to change

(Tm, Tn, TP)=Temp[J] Get array address of next to change

Red(initial[Tm,Tn])=Red(final[Tm,Tn]) Set red value

Green(initial[Tm,Tn])=Green(final[Tm,Tn]) Set green

Blue(initial[Tm,Tn])=Blue(final[Tm,Tn]) Set blue

Alpha(initial[Tm,Tn])=0 Set alpha=0 to never change

End

Z=Z+C Increment the number of zero-alpha pixels

End

The above example process uses a texture of “A” by “B” pixels as an example, and there are N intermediate steps for the transformation, wherein A, B and N are all integer numbers. Each pixel has its red, green, and blue components, and the control value. These values can be changed in the computer storage 20 (FIG. 1) in the local computer 30 and then transmitted to the graphics subsystem 24. Such a computer program for processing the transformation is free to change the color values and the control values of any pixel. At each intermediate step, pixels to be changed will be processed by copying the red, green, and blue values of the final texture to the corresponding position in the initial texture, and the alpha value of the pixel will be set to zero thereafter so that no more change will be made in subsequent steps.

In particular, if there are A times B pixels in the initial texture, and among which there are “Z” number of pixels having zero as its control value, thus there are altogether “C” number, i.e., (A times B) minus Z, of pixels left to transform. If it is determined that all C pixels must be changed in N steps, the number of pixels to change in each step is S, where S=C/N. If this result is not an integer, the next integer immediately smaller than S is used.

In one example, from all C pixels, S pixels may be selected according to the following rules:

a. a probability factor is first calculated wherein the probability factor P=(S/C)×(control value)/255, and the alpha value is a weighted factor for selecting the pixel at each step, and

b. S pixels are selected according to the probability factor to change.

After S pixels are selected, the colors of which in the initial texture in the computer storage 20 are changed by copying the color values of the corresponding pixels in the final texture. Once done, the alpha values of these pixels are set to zero. Then, the changed initial texture is transmitted from the computer storage 20 to the graphics subsystem 24 as the next texture to be displayed. Similar processing steps are taken to convert the remaining (C−S) pixels in (N−1) steps. After N−1 more iterations, the graphics subsystem 24 should be able to display the successfully transformed texture.

In another embodiment, a color-transition method is used. In each intermediate texture, the new intermediate color value is obtained as a function of the initial and final color red, green, and blue values and the number of intermediate textures expected.

As shown in FIG. 4, the initial texture of an image is changed into its final texture by altering the color values (red, green, blue) at a step value each time for each quadrant of the image. The initial texture 90 is first segmented into four quadrants. Changes of the color value can be made to each quadrant with a predetermined step value. If it is determined that the color is expected to change one quarter of the color value difference between the initial and final textures, each quadrant is going to reflect the change in each intermediate step. For instance, if in the initial texture 90, the four quadrants have color values of:

| | |
|---|---|
| (40, 120, 80) | (240, 240, 0) |
| (200, 40, 0) | (0, 0, 0) |

and in the final texture 98, the four quadrants have color values of:

| | |
|---|---|
| (240, 240, 0) | (0, 240, 240) |
| (80, 120, 240) | (120, 40, 240) |

In moving to the first intermediate texture 92, the color values are changed at a pace of the defined step value for each quadrant. That is, the resulting color values at the first intermediate texture 92 are:

| | |
|---|---|
| (90, 150, 60) | (180, 240, 60) |
| (170, 60, 60) | (30, 10, 60) |

Similarly, the second intermediate texture 94 has its color values of:

| | |
|---|---|
| (140, 180, 40) | (120, 240, 120) |
| (140, 80, 120) | (60, 20, 120) |

and the third intermediate texture 96 has corresponding color values of:

| | |
|---|---|
| (190, 210, 20) | (60, 240, 180) |
| (110, 100, 180) | (90, 30, 180) |

Logically, if the control values of any portion of the initial texture is set as zero, indicating that the color is not expected to change in the transition or the changes have been made, then there will not be any further change made to the existing texture.

The following is an example of representative pseudo code illustrating the process for transforming the image from its initial texture to the final texture by using the color-transition method.

Let initial[m:n] be the m by n array containing the initial texture

Let final[m:n] be the m by n array containing the final texture

Each element of initial and final are a 4-tuple of (R, G, B, A) containing the reg, green, blue, and alpha values of the pixel

Let N be the number of textures to build and send to the graphics subsystem; this will be calculated as the maximum alpha

Z=0 The number of pixels with alpha=0

N=0 Maximum alpha found

For I=1 to m Search the initial array and count alpha=0

For J=1 to n

If alpha(initial[I,J])=0 then Z=Z+1

If alpha(initial[I,J])>N then N=alpha(inifial[I,J])

End

End

P=m*n−Z Number of non-zero alpha pixels to change

For I=1 to N Build each new texture

For J=1 to m Process rows

For K=1 to n Process columns

If Alpha(initial[J,K])>0

DeltaR=floor((Red(final[J,K])−

Red(initial[J,K]))/Alpha(initial[J,K]))

Red(iniital[J,K])=Red(iniital[J,K])+DeltaR Add delta to initial

DeltaG=floor((Green(final[J,K])−

Green(initial[J,K]))/Alpha(initial[J,K]))

Green(iniital[J,K])=Green(iniital[J,K])+DeltaG Add delta to initial

DeltaB=floor((Blue(final[J,K])−

Blue(initial[J,K]))/Alpha(initial[J,K]))

Blue(iniital[J,K])=Blue(iniital[J,K])+DeltaB Add delta to initial

Alpha(initial[J,K])=Alpha(initial[J,K])−1

Endif

End

As shown in the program, the number of steps taken between the initial and final textures equals to the largest number of the control values represented in the initial texture (e.g., a number “N”). In essence, the pixels with this control value will reach the color value of the final texture in the Nth step. Pixels with a control value “M,” which does not equal to and smaller than N, will reach the final color value in the Mth step. The initial and final textures are first read into the computer storage 20. The initial texture is interrogated to produce the largest alpha value of any pixel. This is the number for intermediate textures, and is sent to the graphics subsystem 24 along with the initial texture. The following calculations are made for all pixels where the control value is greater than zero for each texture.

new red value=((final red value)−(initial red value))/(initial alpha value) +(initial red value) (1)

Similar calculations are made to obtain new values for blue and green components. Every time a new color value is calculated, the control value is decremented by 1. The change in the color values transforms the image, and the newly obtained texture is sent to the graphics subsystem for further display.

When the control value is initially set as 1, the full difference in color values between the final and the initial textures is added to the initial value immediately, and the pixel is no longer changed by any further computer processes.

The processes described have various advantages due to the improved efficiency in creating and displaying computer graphics on a local computer system. Intermediate textures are created from the initial texture on the local computer and thus the intermediate textures that are conventionally created by graphics artists, stored at a remote computer, and communicated to the local computer may be eliminated. By doing so, the present invention minimizes the number of textures that must be transmitted from the remote to the local computer system and effectively reduces the data traffic between the remote and local computer. More importantly, the local computer can create and transfer data for desired graphics instantly to the graphics subsystem residing close to it instead of waiting for responses from the remote computer system. This effectively improves the responsiveness of the image display on the local computer system.

The present invention may also control the intermediate steps taken for transforming an image from its initial texture to its final desired texture. For instance, by increasing or decreasing the number of intermediate textures, the visual effect of the displayed image can be altered. It also provides graphics artists with full design flexibility as to what pixels or what parts of a texture are to be changed and how fast these changes are to be actually realized.

The present disclosure is described where the textures are transmitted from a remote computer to a local computer for processing. The method of the invention is not dependent on exactly this arrangement, however. It may be the case that the two textures are already located at the local computer; they may have been previously sent from the remote computer, they may be located on a storage device (e.g. magnetic or optical disk) at the local computer, etc. In these cases, the invention operates as described above and provides the same benefits, viz., only the initial and final textures need to be designed with initial and final pixel color and the control value which determines how each pixel is transformed over time.

The present disclosure provides many different embodiments, or examples, for implementing different features of the invention. Specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims. For example, the probability selection method may be combined with the color-transition method to be used for a very large graphic object wherein each method is applied to a portion of the object simultaneously. Other mechanisms may be implemented to determine which method is preferred for certain graphic objects.

What is claimed is:

1. A method for efficiently transforming at least a portion of a graphical image from an initial texture to a final texture to provide a desired visual effect at a first computer system, the first computer system connecting to a second computer system through a communication link, the method comprising:
defining, at the second computer system, the initial and final textures for the portion of the graphical image along with a control value indicating the number of intermediate textures to be displayed between the initial and final textures; and
creating, at the first computer system, the intermediate textures utilizing the control value and the initial and final textures sent by the second computer system to the first computer system.

2. The method of claim 1 wherein the graphic image is defined by one or more pixels, each pixel having at least one color component and a control component associated therewith.

3. The method of claim 2 wherein the control value is the largest value of the control components of all pixels in the initial texture for the portion of the graphical image, the control value being used for determining the number of intermediate textures to be displayed at the first computer.

4. The method of claim 3 wherein the control value is decremented by one for each intermediate texture created, and is set to zero when the final texture is displayed.

5. The method of claim 2 wherein the step of creating further comprises:
determining the difference between the values of the color components of the initial texture and the final texture;
defining a step value for the color components to change between two different textures based on the determined difference;
defining the values of the color components for each intermediate texture based on the values of the color components of the initial texture and the step value; and
displaying each texture at the first computer system.

6. The method of claim 5 wherein the step of displaying further comprises a step of transmitting each texture to a graphic subsystem at the first computer system.

7. The method of claim 1 wherein the step of creating further comprises:
determining randomly one or more pixels in the initial texture to be changed in each intermediate texture based on a probability factor;
setting the values of the color components for each pixel in the intermediate texture based on the color components of the initial and final textures; and
displaying each texture at the first computer system, wherein the probability factor is a function of the control value, the number of pixels need to be selected, and the total number of pixels need to be transformed for the graphical image.

8. A system for efficiently transforming at least a portion of a graphical image from an initial texture to a final texture to provide a desired visual effect at a first computer system, the first computer system connecting to a second computer system through a communication link, the system comprising:
means for defining, at the second computer system, the initial and final textures for the portion of the graphical image along with a control value indicating the number of intermediate textures to be displayed between the initial and final textures; and
means for creating, at the first computer system, the intermediate textures utilizing the control value and the initial and final textures sent by the second computer system to the first computer system.

9. The system of claim 8 wherein the graphic image is defined by one or more pixels, each pixel having at least one color component and a control component associated therewith.

10. The system of claim 9 wherein the control value is the largest value of the control components of all pixels in the initial texture for the portion of the graphical image, the control value being used for determining the number of intermediate textures to be displayed at the first computer.

11. The system of claim 10 wherein the control value is decremented by one for each intermediate texture created, and is set to zero when the final texture is displayed.

12. The system of claim 9 wherein the means for creating further comprises:
means for determining the difference between the values of the color components of the initial texture and the final texture;
means for defining a step value for the color components to change between two different textures based on the determined difference;
means for defining the values of the color components for each intermediate texture based on the values of the color components of the initial texture and the step value; and
means for displaying each texture at the first computer system.

13. The system of claim 12 wherein the means for displaying further comprises means for transmitting each texture to a graphic subsystem at the first computer system.

14. The system of claim 8 wherein the means for creating further comprises:
means for determining randomly one or more pixels in the initial texture to be changed in each intermediate texture based on a probability factor;
means for setting the values of the color components for each pixel in the intermediate texture based on the color components of the initial and final textures; and
means for displaying each texture at the first computer system,
wherein the probability factor is a function of the control value, the number of pixels need to be selected, and the total number of pixels need to be transformed for the graphical image.

15. A method for efficiently transforming at least a portion of a graphical image from an initial texture to a final texture to provide a desired visual effect at a first computer system, the first computer system connecting to a second computer system through a communication link, the graphic image being defined by one or more pixels, each pixel having at least one color component and a control component associated therewith, the method comprising:
defining, at the second computer system, the initial and final textures for the portion of the graphical image along with a control value indicating the number of intermediate textures to be displayed between the initial and final textures; and
determining the difference between the values of the color components of the initial texture and the final texture;
defining a step value for the color components to change between two different textures based on the determined difference;
defining the values of the color components for each intermediate texture based on the values of the color components of the initial texture and the step value; and
displaying each texture at the first computer system utilizing the control value and the initial and final textures sent by the second computer system to the first computer system.

16. The method of claim 15 wherein the control value is the largest value of the control components of all pixels in the initial texture for the portion of the graphical image, the control value being used for determining the number of intermediate textures to be displayed at the first computer.

17. The method of claim 15 wherein the control value is decremented by one for each intermediate texture created, and is set to zero when the final texture is displayed.

18. The method of claim 15 wherein the step of displaying further comprises a step of transmitting each texture to a graphic subsystem at the first computer system.

19. A method for efficiently transforming at least a portion of a graphical image from an initial texture to a final texture to provide a desired visual effect at a first computer system, the first computer system connecting to a second computer system through a communication link, the graphic image being defined by one or more pixels, each pixel having at least one color component and a control component associated therewith, the method comprising:
defining, at the second computer system, the initial and final textures for the portion of the graphical image along with a control value indicating the number of intermediate textures to be displayed between the initial and final textures; and
determining the difference between the values of the color components of the initial texture and the final texture;
determining randomly one or more pixels in the initial texture to be changed in each intermediate texture based on a probability factor;
setting the values of the color components for each pixel in the intermediate texture based on the color components of the initial and final textures; and
displaying each texture at the first computer system utilizing the control value and the initial and final textures sent by the second computer system to the first computer system,
wherein the probability factor is a function of the control value, the number of pixels need to be selected, and the total number of pixels need to be transformed for the graphical image.

20. A method for efficiently transforming at least a portion of a graphical image from an initial texture to a final texture to provide a desired visual effect at a computer system, the graphic image being defined by one or more pixels, each pixel having at least one color component and a control component associated therewith, the method comprising:
determining the difference between the values of the color components of the initial texture and the final texture;
determining randomly one or more pixels in the initial texture to be changed in each intermediate texture based on a probability factor;
setting the values of the color components for each pixel in the intermediate texture based on the color components of the initial and final textures; and
displaying each texture at the computer system utilizing the control value and the initial and final textures
wherein the probability factor is a function of the control value, the number of pixels need to be selected, and the total number of pixels need to be transformed for the graphical image.
